(19) United States
(12) Patent Application Publication
(10) Pub. No.: US 2026/0044489 A1
(43) Pub. Date: Feb. 12, 2026

(54) INTEGRATION OF ATTRIBUTION REPORTS AND AUXILIARY DATA SOURCES

(71) Applicant: Google LLC, Mountain View, CA (US)

(72) Inventors: Lijun Wang, West New York, NJ (US); Srivatsan Ramesh, San Jose, CA (US); Tong Geng, San Mateo, CA (US); Harikesh Sasikumar Nair, Palo Alto, CA (US); Kapil Kumar, San Jose, CA (US); Qing Zhang, Milpitas, CA (US); Fan Zhang, Fair Lawn, NJ (US); Adam Nicholas Smith, Mountain View, CA (US); Chandan Giri, Menlo Park, CA (US)

(21) Appl. No.: 19/293,063

(22) Filed: Aug. 7, 2025

(30) Foreign Application Priority Data
Aug. 8, 2024 (IN) 202411059947

(51) Int. Cl. G06F 16/23; G06F 9/54

(52) U.S. Cl. CPC G06F 16/2365; G06F 9/544

(57) ABSTRACT

The disclosure generally describes methods, software, and systems for integration of attribution reports and auxiliary data sources. Data including aggregated summary reports and event level reports is received from a first system. Additional raw affirmative action data related to the aggregated summary reports and event level reports is received from a second system. A matrix is created with rows for interaction events and columns for raw affirmative action data. Denoised aggregated counts and denoised event counts are determined from the received reports. The matrix fields are optimized by resolving conflicts between raw counts, denoised aggregated counts, and denoised event counts.

### CROSS-REFERENCE TO RELATED APPLICATION

This application claims priority to Indian Patent Application No. 202411059947, fled on Aug. 8, 2024, entitled “Integration Of Attribution Reports And Auxiliary Data Sources,” the entirety of which is hereby incorporated by reference.

### TECHNICAL FIELD

The present disclosure generally relates to computer-implemented methods, software, and systems for integration of event, interaction, and affirmative action data from multiple different and disparate data sources.

### BACKGROUND

Attribution reports facilitate measurements of effectiveness of content display. The attribution report % can be generated, by user systems, from a collection and measurement of digital activity tin the form of interaction data) with respect to digital components provided by a platform (e.g., a content provider). The attribution reports can include interaction data, indicating user activity in response to a presented information package that can be collected by applying different data security measures. The data security measures can include data anonymization, aggregation, information truncation, and addition of noise to protect user privacy. The user privacy protection techniques lead to attribution reports having different partial views of the interaction data that have different granularities and noise levels. The differences make the anonymized interaction data extracted from the attribution reports to appear as conflicting with each other. Content providers can record, independent from the attribution reports, raw affirmative action data including a mix of non-attributable and attributable interactions.

### SUMMARY

Implementations of the present disclosure are directed to techniques and tools for integration of attribution reports and auxiliary data sources. More particularly, implementations of the present disclosure are directed to optimizing interaction data utility by integration of attribution reports and raw affirmative action data.

In some implementations, a method includes: receiving, by one or more processors, data including: (1) aggregated summary reports including hierarchically structured event-attributed affirmative action data as nodes distributed in a plurality of levels, the aggregated summary reports being generated by a first system, (2) event level reports including filtered interaction event data corresponding to interaction-events generated according to multiple affirmative action types that can be reported in a truncated format, the event level reports being generated by the first system, and (3) an additional raw affirmative action data representing raw affirmative action counts, at least a portion of the raw affirmative action counts being related to the hierarchically structured event-attributed affirmative action data and the filtered interaction event data, the additional raw affirmative action data being recorded by a second system; generating, by the one or more processors, a modeling space as a matrix including rows corresponding to interaction events and columns including the raw affirmative action data; determining, by the one or more processors, denoised aggregated counts from the aggregated summary reports and denoised event counts from the event level reports; generating, by the one or more processors, for each field of the matrix, input counts by encoding denoised aggregated counts and denoised event counts using the raw affirmative action data indicative of the interaction data; and optimizing, by the one or more processors, each field of the matrix, to generate an optimized matrix, by applying an optimization objective of selecting either a denoised event or a denoised aggregate, the optimization objective resolving conflicts between informational discrepancy between the raw affirmative action counts, the denoised aggregated counts, and the denoised event counts.

The foregoing and other implementations can each optionally include one or more of the following features, alone or in combination. In particular, implementations can include all the following features:

In a first aspect, combinable with any of the previous aspects, wherein optimizing, by the one or more processors, each field of the matrix includes applying a constraint of having a set sum value for each portion of the matrix. In another aspect, combinable with any of the previous aspects, the auxiliary data includes raw affirmative action counts corresponding to non-attributable affirmative action counts and attributable affirmative action counts. In another aspect, combinable with any of the previous aspects, the attributable affirmative action counts are defined according to an affirmative action type and an affirmative action value. In another aspect, combinable with any of the previous aspects, the optimized matrix includes null values or unitary values in each field, wherein the unitary values indicate attribution of events and null values indicate lack of attribution of events. In another aspect, combinable with any of the previous aspects, the input counts are fractional or negative values. In another aspect, combinable with any of the previous aspects, the computer-implemented method further includes: determining, by the one or more processors, objective weights derived from the input counts; and applying, by the one or more processors, the objective weight, to the input count.

Other implementations of the aspect include corresponding systems, apparatus, and computer programs, configured to perform the actions of the methods, encoded on computer storage devices.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein. For example, the present disclosure also provides a computer-implemented system including: memory storing application programming interface (API) information, and a server performing operations including: receiving, by one or more processors, data including: (1) aggregated summary reports including hierarchically structured event-attributed affirmative action data as nodes distributed in a plurality of levels, the aggregated summary reports being generated by a first system. (2) event level reports including filtered interaction event data corresponding to interaction-events generated according to multiple affirmative action types that can be reported in a truncated format, the event level reports being generated by the first system, and (3) an additional raw affirmative action data representing raw affirmative action counts, at least a portion of the raw affirmative action counts being related to the hierarchically structured event-attributed affirmative action data and the filtered interaction event data, the additional raw affirmative action data being recorded by a second system; generating, by the one or more processors, a modeling space as a matrix including rows corresponding to interaction events and columns including the raw affirmative action data; determining, by the one or more processors, denoised aggregated counts from the aggregated summary reports and denoised event counts from the event level reports; generating, by the one or more processors, for each field of the matrix, input counts by encoding denoised aggregated counts and denoised event counts using the raw affirmative action data indicative of the interaction data; and optimizing, by the one or more processors, each field of the matrix, to generate an optimized matrix, by applying an optimization objective of selecting either a denoised event or a denoised aggregate, the optimization objective resolving conflicts between informational discrepancy between the raw affirmative action counts, the denoised aggregated counts, and the denoised event counts. The present disclosure also provides a non-transitory computer-readable media encoded with a computer program, the computer program including instructions that when executed by one or more computers cause the one or more computers to perform operations including: receiving, by one or more processors, data including: (1) aggregated summary reports including hierarchically structured event-attributed affirmative action data as nodes distributed in a plurality of levels, the aggregated summary reports being generated by a first system, (2) event level reports including filtered interaction event data corresponding to interaction-events generated according to multiple affirmative action types that can be reported in a truncated format, the event level reports being generated by the first system, and (3) an additional raw affirmative action data representing raw affirmative action counts, at least a portion of the raw affirmative action counts being related to the hierarchically structured event-attributed affirmative action data and the filtered interaction event data, the additional raw affirmative action data being recorded by a second system; generating, by the one or more processors, a modeling space as a matrix including rows corresponding to interaction events and columns including the raw affirmative action data; determining, by the one or more processors, denoised aggregated counts from the aggregated summary reports and denoised event counts from the event level reports; generating, by the one or more processors, for each field of the matrix, input counts by encoding denoised aggregated counts and denoised event counts using the raw affirmative action data indicative of the interaction data; and optimizing, by the one or more processors, each field of the matrix, to generate an optimized matrix, by applying an optimization objective of selecting either a denoised event or a denoised aggregate, the optimization objective resolving conflicts between informational discrepancy between the raw affirmative action counts, the denoised aggregated counts, and the denoised event counts.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

Particular embodiments of the subject matter described in this specification can be implemented to realize one or mom of the following advantages relative to third party cookie approaches and isolated processing of application programing interface (API) collected attribution reports. The third party cookie approaches allowed for accurate and refined reports including detailed interaction data directly related to affirmative actions stemming from the recorded interactions. However, such approaches were limited by the amount of privacy control they offered. The techniques described in this specification provide an improved accuracy of analysis of diverse interaction data, collected by APIs of user systems, that optimize integration of interaction data. The API based data reporting approach sacrifices some of the fine-grained information to preserve the privacy of end users. Traditional processing of attribution reports provides a limited usage of the collected interaction data due to conflicting outcomes resulting from inaccurate assumptions coming from incomplete information characterizing the applied privacy protection techniques. For example, the noising technique type applied for generating an attribution report can be known, without revealing particular parameters of the noising technique, such that noisy interaction data can only be replaced with generic data that is not attributable to interaction counts. Different attribution reports include interaction data parameters, collected according to differently set collection sensitivity levels and a maximum number of affirmative actions that can be applied to the interaction data making the traditional API approach deficient. Overcoming the limitations of traditional systems, the described approach provides access to a unified and readily applicable solution that integrates diverse attribution reports with auxiliary data to resolve conflicts and enable a reliable subsequent analysis application. In particular, the described integration of interaction data minimizes system resources, by applying an optimization approach that achieves an self-consistent identification of the attributable interaction data as a first try outcome by augmenting interaction data derived from the attribution reports according to present techniques using data from auxiliary sources. The raw affirmative action data cannot be directly appended to the API derived interaction data because of the undistinguishable mixture of attributable and non-attributable interaction data. The techniques described herein provide a novel approach to combine interaction data derived from the attribution reports and data from auxiliary sources by optimizing a matrix field using determined denoised event counts and input counts. The optimization of the matrix fields achieves a higher quality and an increased accuracy of attributable interaction data that continue to be privacy preserving and anonymized.

As another advantage, adaptation of data collection to multiple types of API configurations can enable flexibility of technology integration. The generation of statistical data including interaction measurements and consumption of the statistical data can be faster than in conventional systems, in which separate different protocols are applied. The generation of statistical data by merging event-level data, aggregated summary reports, and auxiliary data increases accuracy of the interaction measurements, by leveraging the combined use of the API data that provides better measurement fidelity than using either attribution report type in isolation without the auxiliary data because it enables conflict resolution. Along with the interaction data, the configuration of attribution reporting application programming interfaces enables selection of additional collectable information associated with the interaction.

The details of one or more implementations of the subject matter of the specification are set forth in the accompanying drawings and the description below. Other features, aspects, and advantages of the subject matter can become apparent from the description, the drawings, and the claims.

### DESCRIPTION OF THE DRAWINGS

The accompanying drawings, which are incorporated in and constitute a part of this specification, show particular aspects of the subject matter disclosed herein and, together with the description, help explain some of the principles associated with the disclosed implementations. In the drawings,

FIG. 1 is a block diagram of an example system that can be used to execute implementations of the present disclosure.

FIG. 2 is a block diagram of another example system, according to some implementations of the present disclosure.

FIG. 3 depicts a schematic diagram illustrating an example optimized matrix generation, in accordance with some example implementations.

FIG. 4 depicts a flowchart of an example process, in accordance with some example implementations.

FIG. 5 depicts a block diagram illustrating a computing system, in accordance with some example implementations.

When practical, like labels are used to refer to same or similar items in the drawings.

### DETAILED DESCRIPTION

Implementations of the present disclosure are directed to techniques and tools for integration of attribution reports and auxiliary data sources. More particularly, implementations of the present disclosure are directed to increasing accuracy of interaction data utility by integration of attribution reports and raw affirmative action data. The attribution reports can be generated by attribution reporting application programming interfaces (ARA) configured to inject noise in a manner that preserves data privacy in a controlled manner. The attribution reports generated by the ARA can have limited visibility into the underlying dataset of interest including attributable affirmative action data. The diverse attribution reports include interrelated interaction data parameters, collected according to a set sensitivity level of an application programming interface for collecting interaction data and a maximum number of affirmative actions to be applied to the interaction data collected within the sensitivity level. The attribution reports can be processed to reconstruct the interaction data use cases via modeling. For example, the interaction data use cases can be determined by processing separate streams of input signals that are (a) at different granularities, (b) each incomplete in their own ways, and (c) sometimes conflicting with each other. The described implementation facilitates blending multiple noisy, incomplete, and sometimes conflicting inputs including attribution reports into a single coherent and fused output.

Some solutions address the problem of integrating data from different types of attribution reports via a sequential approach. The sequential approach can be based on ad-hoc assumptions at each stage of the blending process. For example, blending first input from a first report and a second input from a second report produces an intermediate output that is subsequently blended with a third input of a third report to produce the final output combining the inputs of the three reports. At a high-level, sequential blending approaches have some shortcomings, which collectively fail to solve the problem from the perspective of important downstream use cases. One shortcoming can include overall data losses (because an ad-hoc assumption made earlier in the process can restrict outputs later in the process). Another shortcoming can include unjustified data inflation (because the blending process sometimes incorrectly absorbs positive noises from the APIs). Another shortcoming can include poor data accuracies because not all relevant information from inputs are properly extracted during blending.

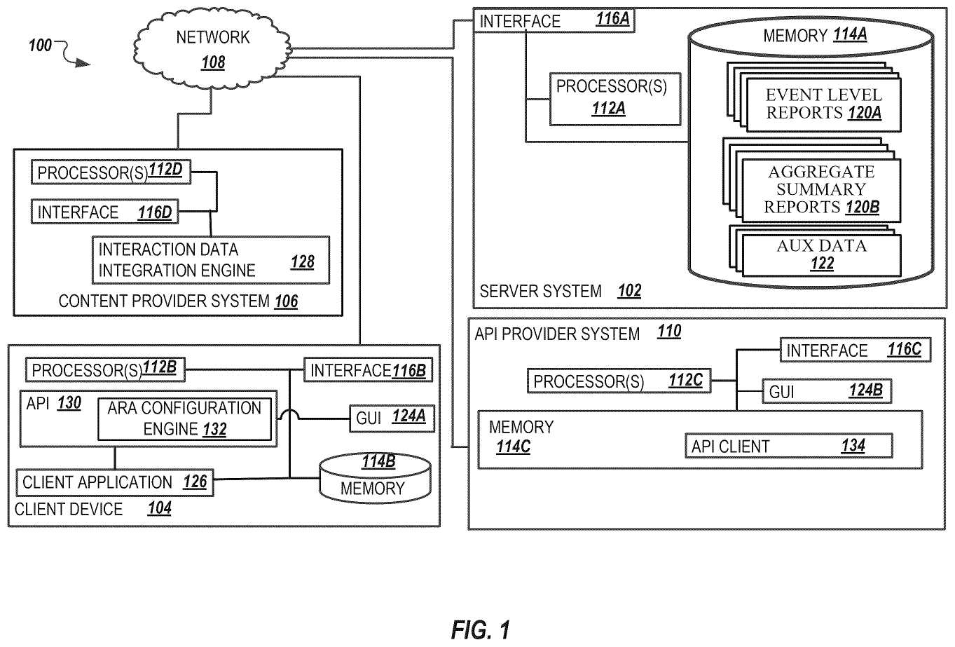

The described data-driven approach solves the problems associated with sequential blending via a single optimization framework applied in a holistic, optimal, and scalable manner to attribution reports and raw affirmative action data. The final output combining the inputs of the attribution reports and raw affirmative action data provides an improved accuracy of analysis of diverse interaction data by optimizing an entire modeling space towards objectives. In particular, the described integration of interaction data minimizes system resources, by applying an optimization approach that achieves an accurate indication of the attributable interaction data as a reliable and accurate outcome. Overcoming the limitations of traditional systems, the described approach provides access to a unified and readily applicable solution that integrates diverse attribution reports with auxiliary data to avoid conflicts and enable a reliable subsequent analysis application. The modeling space optimization can be regulated using feasibility constraints that define an interrelationship between the attribution reports, which are described in detail with reference to FIGS. 1-5.

FIG. 1 is a block diagram of an example system 100 that can be used to execute implementations of the present disclosure. The example system 100 is used for integration of attribution reports and auxiliary data sources including additional raw affirmative action data. The illustrated example system 100 includes or is communicably coupled with a server system 102, a client device 104, a content provider system (and/or asset provider systems) 106, an API provider system 110, and a network 108. Although shown separately, in some implementations, functionality of two or more systems or servers can be provided by a single system or server. In some implementations, the functionality of one illustrated system, server, or component can be provided by multiple systems, servers, or components, respectively.

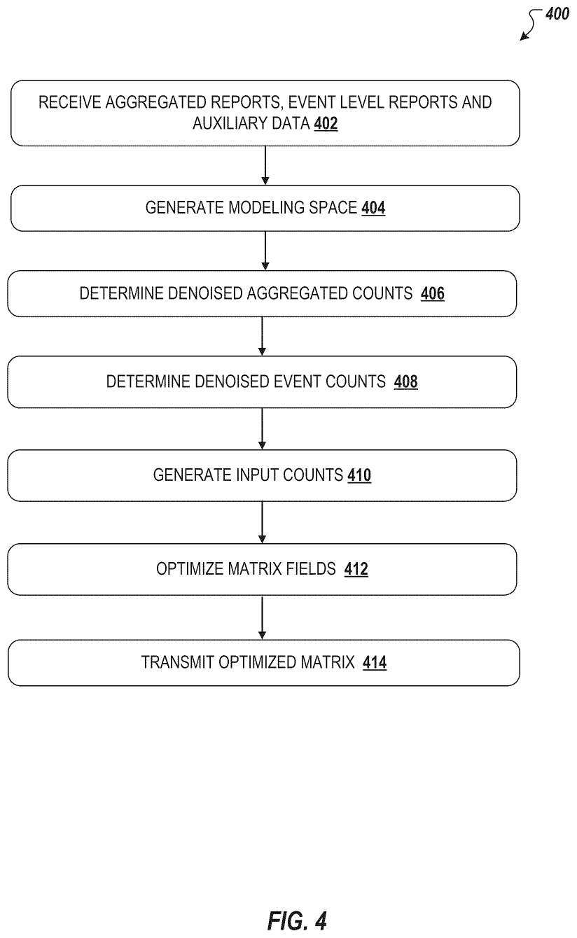

In the example of FIG. 1, the server system 102 is intended to represent various forms of servers including, but not limited to a web server, an application server, a proxy server, a network server, and/or a server pool. In general, server systems 102 accept requests for application services, such as testing services, interaction services, experimental services, and provides such services to any number of client devices 104 (e.g., the client device 104 over the network 108). In accordance with implementations of the present disclosure, and as noted above, the server system 102 can host a solution environment that can be a cloud environment providing software applications, systems, and services, such as content display on client devices 104 within applications that can be consumed by entities as a service. The interaction generated in response to the provided service can be measured and can be provided to content provider systems (and/or asset provider systems) 106. In some instances, the server system 102 can support configuring APIs of different types, as well as services of different types that are integrated in user privacy settings (scenarios) and support execution of processes, as described with reference to FIG. 4.

The server system 102 includes a processor 112A, a memory 114A and an interface 116A. The memory 114A can store attribution reports including event level reports 120A and aggregated summary reports 120B. The memory 114A can also store auxiliary data 122. The event level reports 120A, aggregated summary reports 120B can include documents defining events (e.g., interactions with user interfaces) recorded by resources (APIs) provided by API provider system(s) 110. The auxiliary data 122 provides additional information related to service-interactions and/or affirmative actions. In some implementations, auxiliary data 122 can include an indistinguishable mix of non-attributable and attributable interactions.

The client device 104 and the API provider system 110 can each be any computing device operable to connect to or communicate in the network(s) 108 using a wireline or wireless connection. In general each of the client device 104 and the API provider system 110 includes an electronic computer device operable to receive, transmit, process, and store any appropriate data corresponding to the system 100 of FIG. 1. Each of the client device 104 and the API provider system 110 is generally intended to encompass any computing device such as a laptop/notebook computer, wireless data port, smart phone, personal data assistant (PDA), tablet computing device, one or more processors within these devices, or any other suitable processing device. The client device 104 and the API provider system 110 respectively include interface(s) 116B, 116C, processor(s) 112B, 112C, memories 114, 114C, and graphical user interface(s) (GUIs) 124A, 124B.

The client device 104 can include one or more client applications 126. The client application 126 can be any type of application that allows a client device to request and view content on the client device (e.g., internet browsers). In some implementations, a client application 126 can correspond to an API 130 that can collect user data, additional raw affirmative action data, and other API event information according to parameters set by the ARA configuration engine 132. The settings of the ARA configuration engine 132 are applied to interaction data collection and processing to preserve user privacy data (event level reports 120A, aggregated summary reports 120B). The ARA configuration engine 132 can be included in the API 130, as shown in FIG. 1. The ARA configuration engine 132 can be a part of a privacy tool (e.g., Privacy Sandbox by Google L.L.C.) associated to a client application 126 (e.g., internet browsers). In some instances, the client application 126 can be an agent or client-side version of the one or more enterprise applications running on an enterprise server (not shown). The memory 114C of the target API provider system 110 can include an API client 134 that can be used for integration dependency.

The client device 104 and/or the API provider system 110 can include a computing device that includes an input device, such as a keypad, touch screen, or other device that can accept user information, and an output device that conveys information corresponding to the operation of the server system 102, or the client device itself, including digital data, visual information, or a GUI 124A, 124B, respectively. The GUI 124A, 124B each interface with at least a portion of the system 100 for any suitable purpose, including generating a visual representation of the client application 126 or the administrative application 133, respectively. In particular, the GUIs 124A. 124B can each be used to view and navigate various Web pages. Generally, the GUIs 124A. 124B each provide the user with an efficient and user-friendly presentation of object data (additional raw affirmative action data) provided by or communicated within the system. The GUIs 124A, 124B can each comprise a plurality of customizable frames or views having interactive fields, pull-down lists, and buttons operated by the user during recordable events that can be included in API collected data (e.g., event level reports 120A, aggregated summary reports 120B). The GUIs 124A, 124B each contemplate any suitable graphical user interface, such as a combination of a generic web browser, intelligent engine, and command line interface (CL1) that processes information and efficiently presents the results to the user visually.

The content provider systems (and/or asset provider systems) 106 can include any type of system that provides digital content and/or digital assets over the network 108. For example, the content provider systems (and/or asset provider systems) 106 can include multiple systems that exist in a multi-system landscape. An organization can use different systems, of different types, to run the organization, for example. The content provider systems (and/or asset provider systems) 106 can include systems from the same entity or different entities. The content provider systems (and/or asset provider systems) 106 can each include at least one of an interface 116D, a processor 112D, and an interaction data integration engine 128. The interaction data integration engine 128 can include an implementation of operations associated to statistical data indicative of interaction measurements. The operations implementation capabilities include a set of criteria to select and trigger automatic implementation of an operation based on the statistical event-attributed data. The interaction data integration engine 128 can filter the entity landscape to identify suitable operation target, from multiple asset provider systems 106, based on API configurations and can automatically select an identified API provider systems 110 for establishing connections to any of the client device 104 and/or the API provider system 110, over the network 108.

In some implementations, the network 108 can include a large computer network, such as a local area network (LAN), a wide area network (WAN), the Internet, a cellular network, a telephone network (PSTN) or an appropriate combination thereof connecting any number of communication devices, mobile computing devices, fixed computing devices and server systems. Data exchanged over the network 108, is transferred using any number of network layer protocols, such as Internet Protocol (OP). Multiprotocol Label Switching (MPLS). Asynchronous Transfer Mode (ATM). Frame Relay, etc. Furthermore, in implementations where the network. 108 represents a combination of multiple sub-networks, different network layer protocols are used at each of the underlying sub-networks. In some implementations, the network 108 represents one or more interconnected internetworks, such as the public Internet.

Each processor 112A, 112B, 112C, 112D included in the client device 104, content provider systems (and/or asset provider systems) 106, or the API provider system 110 can be a central processing unit (CPU), an application specific integrated circuit (ASIC), a field-programmable gate array (FPGA), or another suitable component. Generally, each processor 112A, 112B, 112C, 112D included in the client device 104 or the API provider system 110 executes instructions and manipulates data to perform the operations of the client device 104 or the API provider system 110, respectively. Specifically, each processor 112A, 112B, 112C, 112D included in the client device 104 or the API provider system 110 executes the functionality used to send requests to the server system 102 and to receive and process responses from the server system 102. Each processor 112A, 112B, 112C, 112D can be a central processing unit (CPU), a blade, an application specific integrated circuit (ASIC), a field-programmable gate array (FPGA), or another suitable component. Each processor 112A, 112B, 112C, 112D executes instructions and manipulates data to perform the operations of the respective system (the server system 102, the client device 104, the API provider system 110, and the content provider systems (and/or asset provider systems) 106). Specifically, each processor 112A, 112B, 112C, 112D executes the functionality used to receive and respond to requests from the respective system (the server system 102, the client device 104, the API provider system 110, and the content provider systems (and/or asset provider systems) 106), for example.

Interfaces 116A, 116B, 116C, 116D are used by the server system 102, the client device 104, the content provider system 106, and the API provider system 110, respectively, for communicating with other systems in a distributed environment—including within the system 10—connected to the network 108. Generally, the interfaces 116A, 1168, 116C, 116D each include logic encoded in software and/or hardware in a suitable combination and operable to communicate with the network 108. More specifically, the interfaces 116A, 116B, 116C, 116D can each include software supporting one or more communication protocols corresponding to communications such that the network 108 or interface's hardware is operable to communicate physical signals within and outside of the illustrated system 100.

The memory 114A, 114B, 114C can include any type of memory or database engine and can take the form of volatile and/or non-volatile memory including, without limitation, magnetic media, optical media, random access memory (RAM), reservice-only memory (ROM), removable media, or any other suitable local or remote memory component. The memory 114A, 114B, 114C, can store various objects or data, including caches, classes, frameworks, applications, backup data, objects, jobs, web pages, web page templates, database tables, database queries, repositories storing entity information and/or dynamic information, and any other appropriate information including any parameters, variables, algorithms, instructions, rules, constraints, or references thereto corresponding to the purposes of the server system 102, the client device 104, the API provider system 110, or the content provider system 106, respectively.

There can be any number of client devices 104 and API provider systems 110 corresponding to, or external to, the system 100 for collecting and processing interaction event data. Additionally, there can also be one or more additional client devices external to the illustrated portion of system 100 that are capable of interacting with the system 100 via the network(s) 108. Further, the term “client,” “client device,” and “user” can be used interchangeably as appropriate without departing from the scope of the disclosure. Moreover, while client device can be described in terms of being used by a single user, the disclosure contemplates that many users can use one computer, or that one user can use multiple computers. As used in the present disclosure, the term “computer” is intended to encompass any suitable processing device. For example, although FIG. 1 illustrates a single server system 102, a single client device 104, a single API provider system 110, the system 100 can be implemented using a single, stand-alone computing device, two or more servers 102, or multiple client devices. The server system 102, the client device 104 and the API provider system 110 can include any computer or processing device such as, for example, a blade server, general-purpose personal computer (PC). Mac®, workstation, UNIX-based workstation, or any other suitable device. In other words, the present disclosure contemplates computers other than general purpose computers, as well as computers without conventional operating systems. Further, the server system 102 and the client device 104 and the API provider system 110 can be adapted to execute any operating system or runtime environment, including Linux, UNIX, Windows, Mac OS®, Java™, Android™, iOS, BSD (Berkeley Software Distribution) or any other suitable operating system. According to one implementation, the server system 102 can also include or be communicably coupled with an e-mail server, a Web server, a caching server, a streaming data server, and/or another suitable server.

Regardless of the particular implementation, “software” can include computer-readable instructions, firmware, wired and/or programmed hardware, or any combination thereof on a tangible medium (transitory or non-transitory, as appropriate) operable when executed to perform at least the processes and operations described herein. Indeed, each software component can be fully or partially written or described in any appropriate computer language including C. C++, Java™, JavaScript®, Visual Basic, assembler, Perl®, ABAP (Advanced Business Application Programming), ABAP 00 (Object Oriented), any suitable version of fourth-generation programming language, as well as others. While portions of the software illustrated in FIG. 1 are shown as individual engines that implement the various features and functionality through various objects, methods, or other processes, the software can instead include multiple sub-engines, third-party services, components, libraries, and such, as appropriate. Conversely, the features and functionality of various components can be combined into single components as appropriate.

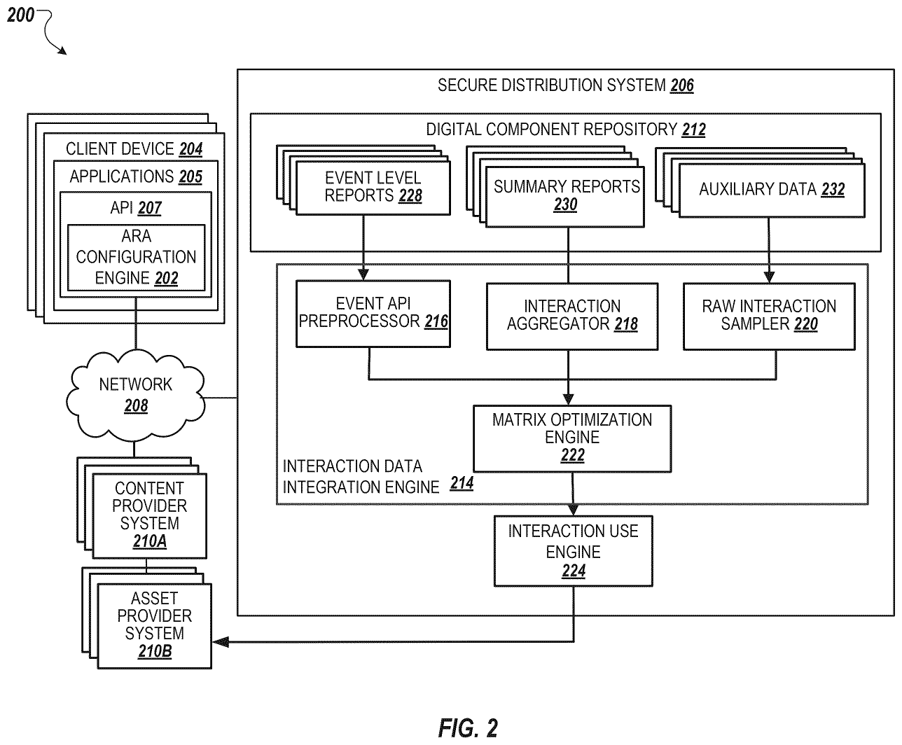

FIG. 2 is a block diagram of another example system 200, according to some implementations of the present disclosure. The example system 200A includes a system for secure collection and distribution of interaction data using an ARA configuration engine 202. The illustrated example system 200 includes or is communicably coupled with a client device 204, a secure distribution system 206, network. 208, a content provider system 210A, and an asset provider system 210B.

The client device 204 can include applications 205, such as web browsers and/or native applications, to facilitate the sending and receiving of data over the network 208. A native application is an application developed for a particular platform or a particular device (e.g., mobile devices having a particular operating system). Although operations can be described as being performed by the client device 204, such operations can be performed by an application 205 running on the client device 204. The applications 205 can present electronic resources, e.g., web pages, application pages, or other application content, to a user of the client device 204. The electronic resources can include digital component slots for presenting digital components with the content of the electronic resources. A digital component slot is an area of an electronic resource (e.g., web page or application page) for displaying a digital component. A digital component slot can also refer to a portion of an audio and/or video stream (which is another example of an electronic resource) for playing a digital component.

An electronic resource is also referred to herein as a resource for brevity. For the purposes of the document, a resource can refer to a web page, application page, application content presented by a native application, electronic document, audio stream, video stream, or other appropriate type of electronic resource with which a digital component can be presented. As used throughout the document, the phrase “digital component” refers to a discrete unit of digital content or digital information (e.g., a video clip, audio clip, multimedia clip, image, text, or another unit of content). A digital component can electronically be stored in a physical memory device as a single file or in a collection of files, and digital components can take the form of video files, audio files, multimedia files, image files, or text files and include interaction information, such that an interaction is a type of digital component. For example, the digital component can be content that is intended to supplement content of a web page or other resource presented by the application 205. More specifically, the digital component can include digital content that is relevant to the resource content (e.g., the digital component can relate to the same topic as the web page content, or to a related topic). The provision of digital components can supplement, and generally enhance, the web page or application content.

In response to the application 205 loading a resource that includes a digital component slot, the application 205 can generate a digital component request 225 that requests a digital component, for presentation in the digital component slot. In some implementations, the digital component slot and/or the resource can include code (e.g., scripts) that cause the application 205 to request a digital component from the content provider system 210A that can be recorded by the API 207, according to data collection settings defined by the ARA configuration engine 202, as interaction data.

The interaction data collected by the AP 207 can be processed using one or more operations, according to data collection settings defined by the ARA configuration engine 202, to generate attribution reports including event-level attributable counts of interaction data that are noisy and truncated. The attribution reports include interaction data related to the client device 204 and/or non-sensitive data, such as query strings. The interaction data can be grouped based on different criteria, including services associated to the interactions and/or parameters of the client device 204.

The client device 204 can include controls (e.g., user interface elements with which a user can interact) allowing the user to provide a user input that can be recorded as a user interaction. For example, the client device 204, the applications 205, and the APIs 207 can facilitate collection of user information (e.g., information about a user's social network, social actions, or activities, profession, a user's preferences, or a user's current location), according to data collection settings defined by the ARA configuration engine 202. The ARA configuration, set and adjusted using the ARA configuration engine 202, can include data collection parameters and affirmative action parameters defining operations applied to interaction data to generate reports, such as the event level reports 228 and summary reports 230. For example, according to the configuration of ARA, attribution of affirmative action from the interaction data can be defined according to an affirmative action type and an affirmative action value. The affirmative action attribution includes an assignment of an affirmative action activity to an appropriate prior service-interaction(s). The affirmative action type includes a description of the affirmative action, such as user interaction results (e.g., purchase of an item, a page view, subscription). The affirmative action value includes a value to the content provider of an affirmative action, which may be expressed in currency units. The affirmative action data includes user actions relevant for a content provider, such as a visit or interaction with a website, which service-techs report and optimize for on behalf of asset providers. The affirmative action data and other data extracted from the interaction data are included in reports generated according to ARA configuration. In addition, interaction data can be processed in one or more ways, according to data processing settings defined by the ARA configuration engine 202, before it is transmitted to be stored, by the digital component repository 212 of the secure distribution system 206 or used, so that personally identifiable information is truncated (at least partially removed) and noise is added to hide private user data. For example, private data can be truncated so that no personally identifiable information can be determined, or a geographic location can be generalized where location information is obtained (such as to a city, ZIP code, or state level), so that a particular location of the device cannot be determined. The user can have control over the settings of the ARA configuration engine 202 defining what information is collected about the user, how that information is used, and what information is provided to the content provider system 210A and the asset provider system 210B.

Interaction event data, recorded by the API 207, can also include contextual data, which is generally considered non-sensitive. The contextual data can describe the environment, in which a selected digital component was presented. The contextual data can include, for example, coarse location information indicating a general location of the client device 204 that sent the digital component request, a resource (e.g., website or native application) with which the selected digital component can be presented, a spoken language setting of the application 205 or client device 204, the number of digital component slots, in which digital components are presented with the resource, the types of digital component slots, and other appropriate contextual information.

The secure distribution system 206 can be included in a server system (e.g., server system 102 described with reference to FIG. 1). Although shown separately, in some implementations, the secure distribution system 206 can be included in any of the client device 204 (e.g., client device 104 described with reference to FIG. 1), the content provider systems 210A (e.g., system 106 described with reference to FIG. 1), or the asset provider system 210B (e.g., system 106 described with reference to FIG. 1) or can be communicatively coupled over the network 208 (e.g., network 108 described with reference to FIG. 1) to any of the client device 204, the content provider system 210A, and the asset provider system 210B. The secure distribution system 206 can be implemented using one or more server computers (or other appropriate computing devices), that can be distributed across multiple locations. In general, the secure distribution system 206 receives requests for digital components from client devices 204, selects digital components based on data included in the requests, and sends the selected digital components to the client devices 204. In some implementations, the secure distribution system 206 can be operated and maintained by an independent trusted party, e.g., a party that is different from the users of the client devices, the parties that operate supply side platform (SSP) and demand side platforms (DSPs), and the digital component providers, to ensure security and privacy with respect to the data. For example, the secure distribution system 206 can be operated by an industry group or a governmental group.

The secure distribution system 206 can include a digital component repository 212 and a data integration engine 214. The data integration engine 214 can include an event API preprocessor 216, an interaction aggregator 218, a raw affirmative action sampler 220, a matrix optimization engine 222, and an interaction use engine 224. The digital component repository 212 can be a database configured to store data including data received from API such as additional raw affirmative action data 232, event level reports 228, summary reports 230, and additional raw affirmative action data 232.

The event level reports 228 and the summary reports 230 can include eventified and modeled data logs of interaction data collected by the API 207 of the client device 204, during a set reporting window (e.g., a selected number of days or weeks). The event level reports 228 and the summary reports 230 can be transmitted by the client device 204 to the secure distribution system 206. The event level reports 228 and the summary reports 230 can reflect the same information content in two types of reports that provide different levels of granularity (one more detailed, and one more in summary form). The event level reports 228 and the summary reports 230 include tabulated logs with rows representing interaction-events and columns representing the outcomes (affirmative action counts and associated values) attributed to the interaction-events.

The additional raw affirmative action data 232 can include individual affirmative action counts that are associated with interaction data (attributable data) and affirmative action counts that are unrelated to any interaction data (non-attributable data). The individual raw affirmative action counts can be collected during the set reporting window by an external system, such as the content provider system 210A and/or the asset provider system 210B. The individual raw affirmative action counts can be transmitted, by the content provider system 210A and/or the asset provider system 210B, to the secure distribution system 206. The secure distribution system 206 can use a client device identifier and the set reporting window to combine interaction data (from the event level reports 228 and the summary reports 230) and individual raw affirmative action counts to generate an optimized matrix. A first portion of interaction data can be related to a first portion of raw affirmative action counts included in the additional raw affirmative action data 232 (e.g., content triggered interactions can be followed by affirmative actions). A second portion of interaction data can be unrelated to any portion of the raw affirmative action counts (e.g., not being followed by affirmative action). A second portion of raw affirmative action counts can be unrelated to any portion of the interaction data (e.g., affirmative actions can be isolated from content triggered interactions). In some implementations, the additional raw affirmative action data 232 can be formatted as metadata.

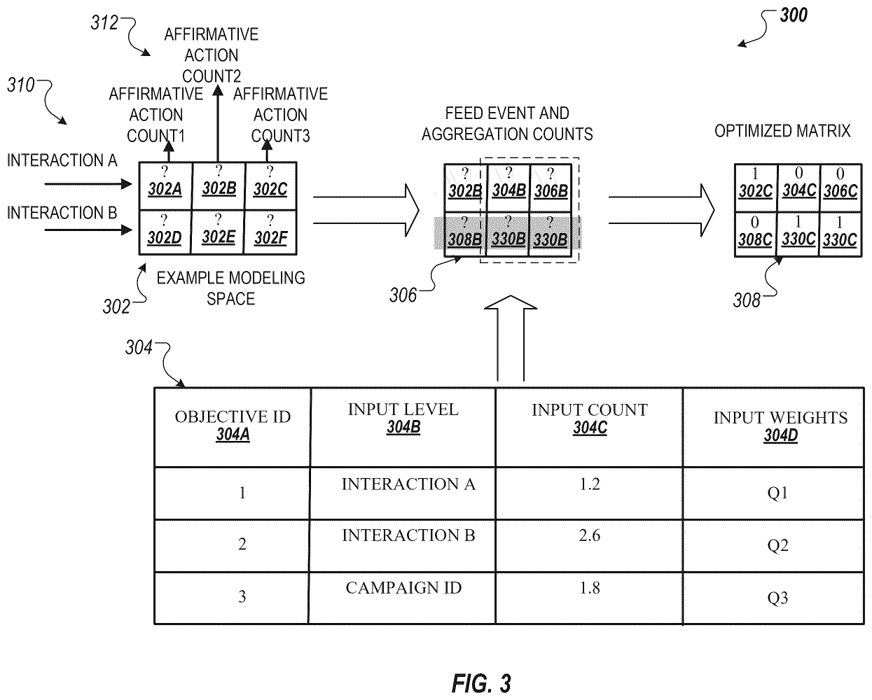

The data integration engine 214 (e.g., the matrix optimization engine 222) can access (obtain or retrieve) the interaction data from the event API preprocessor 216 and the interaction aggregator 218. The data integration engine 214 (e.g., the matrix optimization engine 222) can process the interaction data with the additional raw affirmative action data 232 received from the content provider system 210A or the digital component repository 212 (storing auxiliary data 232 received from the content provider system 210A) and provide an output as an optimized matrix to. For example, the event API preprocessor 216 can be configured to process the input received from the event level reports 228 retrieved from the digital component repository 212 to generate an output that is provided to the matrix optimization engine 222. The interaction aggregator 218 can access (obtain or retrieve) the summary reports 230 from the digital component repository 212 and provide an output of interaction data processing to the matrix optimization engine 222. The data integration engine 214 can use the matrix optimization engine 222 to simultaneously integrate inputs from the event level reports 228, the summary reports 230, and the additional raw affirmative action data 232, extracted by the event API preprocessor 216, an interaction aggregator 218, a raw affirmative action sampler 220. The matrix optimization engine 222 can generate an optimized matrix including the integrated data. The data integration engine 214 can use the matrix optimization engine 222 to filter out some affirmative action counts by applying objective weights that can increase accuracy of the output data included in the optimized matrix. The matrix optimization engine 222 can be in a format that the content provider system 210A and/or the asset provider system 210B can interpret, such as for use cases that can be identified by the interaction use engine 224. Further details regarding the operations executed by the matrix optimization engine 222 are provided with respect to FIG. 3.

The optimized matrix including the integrated data is sent to the interaction use engine 224 and, optionally, to the content provider system 210A and the asset provider system 210B. The interaction use engine 224 can process the optimized matrix to identify use cases associated to the debiased data. The interaction use engine 224 can send the use cases associated to the debiased data or a control command associated to one or more the use cases to the content provider system 210A and the asset provider system 210B,

FIG. 3 depicts a schematic diagram 300 illustrating an example optimized matrix generation, in accordance with some example implementations. The schematic diagram 300 includes an example modeling space 302, an input matrix 304, an event and aggregation count matrix 306, and an optimized matrix 308.

The example modeling space 302 includes a matrix for each content provider. The example modeling space 302 includes multiple rows 310 corresponding to affirmative actions (e.g., interactions with a graphical interface). The example modeling space 302 includes multiple columns 312 corresponding to raw affirmative action counts recorded by a computing device (e.g., client device 104, 204 discussed with reference to FIGS. 1 and 2). Each raw affirmative action count can be used once, thus rendering its value between 0 and 1. Each field of the example modeling space 302 includes a numerical value that reflects an indistinguishable mix of non-attributable and attributable affirmative actions.

The input matrix 304 includes a matrix including multiple columns corresponding to optimization objectives 304A, input level 304B, input count 304C, and, optionally, input weights 304D. The optimization objectives 304A can include denoised affirmative action numbers from event de-noising. The input level 304B can include event-level affirmative action counts determined, from event level reports, by reporting window and can be denoised using corresponding metadata. The input count 304C can include slice-level affirmative action counts. The slice-level affirmative action counts include keys (e.g., occurrences or frequencies) of affirmative action counts within a particular subset (slice) of a dataset that can correspond to an affirmative action type. The slice-level affirmative action counts can be determined, from aggregated summary reports by pre-specified slicing keys. The input weights 304D include weights (scalar values) determined as affirmative action counts across slices. The input weights 304D can be derived from the accuracy of inputs.

The event and aggregation count matrix 306 includes encoded event-level counts and encoded aggregation-level counts being applied into the modeling space according to an optimization procedure, as described with reference to FIG. 4. The optimized matrix 308 includes the modeling space mathematically optimized towards all mathematical optimization objectives (e.g., single objective optimization and/or multi-objective optimization), while subject to a hard feasibility constraint of having at most a single unitary (1) value in each column (to ensure zero double-counting across all models at the content provider-level). The optimized matrix 308 includes multiple fields with a null value or unitary value (where 1 indicates a modeled attribution and 0 indicates a non-attributable affirmative action count).

Within a context example, the affirmative action category can have a number of conditions. In the first row of the illustrated input matrix 304 an interaction can lead to two affirmative actions, leading to a fractional number after denoising. The affirmative action counts are also limited by the reporting window. The affirmative action counts can be further grouped based on the affirmative action type. The rows and the columns of the optimized matrix can be mapped, during the feeding process, per region of question marks that is corresponding to the particular denoised event and aggregation count. In the illustrated example, the top row shaded with light grey corresponds to the input count 1.2. The feed event and aggregation count mapping indicates that all the question marks in the top row shaded with light grey sum up to 1.2. Likewise for the second interaction, the sum of the entries in the bottom row shaded with dark grey corresponds to the input count 2.6. The third input count 1.8 corresponds to the sum of the set of slicing keys entries (middle and right columns) encircled by the dashed lines. Knowing the sums per different sections of the matrix, the individual entries can be determined by applying multiple rules. In some implementations, these rules are not consistent with each other. The conflicts can be resolved by applying individual objectives that are used by the optimization framework. The optimization framework determines the binary (0 or 1) entries for each field of the optimized matrix 308 as individual objectives and then optimizes the final solution so that it minimizes the distance between the final outcome in the individual objectives in a matrix of objectives, at a high level view. The distance is minimized using an optimization objective, as described with reference to FIG. 4.

FIG. 4 depicts a flowchart of an example process 400, according to some implementations of the present disclosure. The example process 400 can be executed using, e.g., any component of the example system 100 described with reference to FIG. 1 or example system 200 described with reference to FIG. 2. Operations of the process 400 are described below for illustration purposes only. Operations of the process 400 can be performed by any appropriate device or system. e.g., any appropriate data processing apparatus. Operations of the process 400 can also be implemented as instructions stored on a computer readable medium which can be non-transitory. Execution of the instructions causes one or more data processing apparatus to perform operations of the process 400.

At 402, interaction data is received. The interaction data includes attribution reports and additional raw affirmative action data. The attribution reports include aggregated summary reports and event level reports.

The event-level and aggregated summary reports represent two different views of the same underlying interaction data corresponding to different anonymization and privacy preserving techniques. The aggregated summary reports include data aggregates generated by grouping converted data including event-attributed affirmative action data that is aggregated as data slices at one or more levels. The aggregated summary reports are configured based on a pre-definition of the slices, over which an interaction provider system plans to learn about event-attributed affirmative action activity. For example, the aggregated summary reports can include hierarchical structured data including a parent node and one or more child nodes, each node including a key corresponding to an associated service identifier, an affirmative action type, and a number of aggregated affirmative action count values per each node. The aggregated summary reports include hierarchically structured event-attributed affirmative action data as nodes distributed in a plurality of levels. The aggregated summary reports are associated with additional raw affirmative action data corresponding to an affirmative action type applied to the structured event-attributed affirmative action data. The event level reports include filtered interaction event data corresponding to interaction-events generated according to multiple affirmative action types that can be reported in a truncated format. For example, the event level reports can include tabular structured data (e.g., data tables) including interaction identifiers, associated service identifiers, affirmative action count types, and affirmative action count values per each interaction count type. Event level reports are received from application programming interfaces (APIs) of different source systems that can have different ways to expose additional raw affirmative action data corresponding to APIs and events. The nature of the data generated by both is a function of how each transforms the same underlying data to preserve user privacy. The described process includes a derivation of interaction activity measurement based on applied data privacy transformations. For example, the described technology considers two aspects of working with the API data; affirmative action truncation and noise considerations, and how these aspects differ for each of the API, according to respective configurations. The term “event” in event-level reports corresponds to interaction-events. That is, the event-level reports include a report with a granularity defined by an interaction, such as a click or a view. The additional raw affirmative action data include raw affirmative actions recorded by a computing system.

At 404, a modeling space (e.g., example modeling space 302 described with reference to FIG. 3) for the interaction data is generated. The modeling space can be formatted as a matrix having a dimension defined by configuration settings selected by a content provider system (e.g., content provider system 106, 210A described with reference to FIGS. 1 and 2). The modeling space can include multiple rows corresponding to affirmative actions (e.g., interactions with a graphical interface) and can include multiple columns corresponding to raw affirmative action counts recorded by a computing device (e.g., client device 104, 204 discussed with reference to FIGS. 1 and 2). Each raw affirmative action count can be used at most once being smaller or equal to a unitary value, where the unitary value (i) indicates a modeled attribution and null (0) indicates a non-attributable affirmative action count.

At 406, denoised aggregated counts are generated from the aggregated summary reports. The denoised aggregated counts can be generated by determining false positives, by removing false positives, and by determining and removing noise. False positives can be determined by analyzing the “hierarchical” structure of the aggregated summary reports relative to an event-level report. The “hierarchical” structure includes an arrangement of aggregates in a tree-like structure, where parent “leaves” are split into children “leaves” with each additional aggregation key. The hierarchy of the aggregated summary reports includes aggregate slices corresponding to parent event nodes and children event nodes. The branches (aggregate slices) including one or more nodes that are identified as being unrelated to an event-level report are identified as false positive reports that are removed from the aggregated summary reports. The portion of the “hierarchical” structure remaining after false positive removal is processed for noise identification and removal matching the noising mechanism applied to generate the aggregated summary reports (e.g., a Laplace noising mechanism). For example, the noise can be reduced from all slices of the aggregated summary reports applying a matching denoising mechanism (e.g., determining linear weighted averages of aggregates or applying a skewed weighted average). The denoised aggregated counts are consistent in that each slice's affirmative action count is exactly equal to the sum of its children.

At 408, denoised event counts are generated from the event level reports. The denoised event counts can be generated by determining invalid metadata, by removing fake branches, and by determining and removing noise. The events in the event level exports can be filtered based on respective metadata entries that can be mapped to the events. If the metadata for an identified log entry is not registered inside the metadata mapping table, it is determined that the affirmative action (configuration) of the log entry is on the fake branch, the respective metadata is identified as being invalid for each affirmative action type identifier that facilitates identification of interaction events on the fake branch. The interaction events on the fake branch can be reduced to improve the signal-noise ratio and obtain higher accurate estimates. For events that were not certainly identified as being on the fake branch, the probability of each event of being on the fake branch is estimated. The conditional probability can be estimated directly by leveraging the knowledge of the noising mechanism of the event-level API. The events identified as having a high probability to be on a fake branch are removed to generate denoised event counts.

At 410, input counts are generated for each field of the matrix, by encoding denoised aggregated counts and denoised event counts using the raw affirmative action counts indicative of the interaction data. The input counts are generated by formatting the denoised aggregated counts, the denoised event counts, and the additional raw affirmative action data as an input matrix (e.g., input matrix 304, described with reference to FIG. 3). The input matrix includes multiple columns corresponding to optimization objectives, input level, input count, and, optionally, input accuracy. The optimization objectives can include denoised affirmative action numbers from event de-noising. The input level can include event-level affirmative action counts determined, from event level reports, by reporting window. The input count can include slice-level affirmative action counts determined, from the denoised aggregated counts. The input weights can include weights (scalar values) determined as affirmative action counts across slices. The input weights can be derived from the accuracy of inputs and can be include in the input matrix to increase the accuracy of the optimized matrix.

At 412, an optimized matrix is generated, by applying for each field of the matrix a mathematical optimization objective of selecting either a denoised event or a denoised aggregate (or both when they overlap). The optimized matrix can emulate the characteristics of a convex optimization problem and is configured to be fed into a simplex algorithm with primal-dual gradient method along with Markowitz pivoting to improve the speed and precision in deriving the optimal solutions for the problem which is attributing the right click to a conversion. The optimization objective can minimize the discrepancies in information from the APIs (Denoised Events, Denoised Aggregates) such that the information from one of the sources (e.g., “raw affirmative action data” including unattributed conversions) is used as a reference. The optimization objective applies a constrained optimization to the input matrix. The optimization objective defines a mechanism of determining the values of each field (cell) of the optimized matrix, as intended for affirmative action sampling outputs, x. The optimization objective defines a resolution of a resource informational discrepancy between intended outputs, denoised event counts, and denoised aggregated counts. The optimization objective limits the intended affirmative action sampling outputs to affirmative action features available among the raw affirmative action counts. Mathematically, the optimization objective is expressed as:

$${min}_{\text{?}} {\sum }_{\text{?}} \{ w ( Input Accuracy ) \times \vert \sum [ {I}_{\text{?}} ( x ) - {InputCount}_{\text{?}} \vert \} s . t .$$

$$\sum [ {I}_{p} ( x ) ] \leq 1 ∀ p$$

$$\text{?} \text{indicates text missing or illegible when filed}$$

The intended affirmative action sampling outputs, x is represented as a vector with each cell denoting an unknown value in the modeling space. Iᵢ(x) is a selector function choosing X's cells per optimization objective i. Iₚ(x) is a selector function choosing X's cells per raw affirmative action p for all raw affirmative action ∀p. The w(Input Accuracy) can be optionally included in the optimization objective as objective weights derived from accuracy of inputs. The optimized matrix includes zeros or ones in each field. The fields with ones indicate attribution of events corresponding to an interaction that led to an affirmative action. The fields with zeros indicate lack of attribution of events where interaction were dissociated from affirmative actions.

At 414, the optimized matrix (including interaction data associated with affirmative actions) is transmitted to one or more service providing systems to trigger operations of service providing systems that are activated using interaction use cases. The service providing systems can use the interaction use cases for downstream operations. For example, the service providing systems can use the full set of reporting data to make decisions of what types of content to serve to increase an efficiency of data transmission for increasing a correlation between interaction data and affirmative action counts. A trigger to activate the operations of asset providing systems using interaction use cases is generated. The trigger can automatically activate execution of one or more operations corresponding to the determined interaction use cases. The operations can include establishment of a communication channel with the client devices, transmission of the digital components from the database to the client devices, and/or transmission offers corresponding to the digital component from asset providing systems to the client devices. The operations can include an automatic modification of a display of the client devices to increase the visibility of the automatically triggered display of the digital component.

The example process 400 provides the advantage of solving the affirmative action sampling problem without the shortcomings incumbent in prior solutions. For example, the example process 400 generates an optimized matrix including intended affirmative action sampling outputs without data losses, without unjustified data inflations, and with high data accuracy. Furthermore, the example process 40 provides a holistic, optimal, and scalable process. In particular, the example process 400 includes a standard convex problem that is mathematically guaranteed to have an optimal solution (e.g., without concern for the lack of model convergence). As another advantage, the example process 400 provides input flexibility using all denoised event- and aggregated counts as inputs, and can handle cases where input counts are fractional or even negative (e.g., no ad-hoc rounding or capping-at-zero assumptions required). As another advantage, the example process 400 provides compatibility with different interaction data collection mechanisms techniques and use case applications. The example process 400 protects user data privacy and applicability of determined use cases. The data privacy is protected by the example process 400 through replacement of noise with generic data that facilitate applicability of the optimized matrix for use cases.

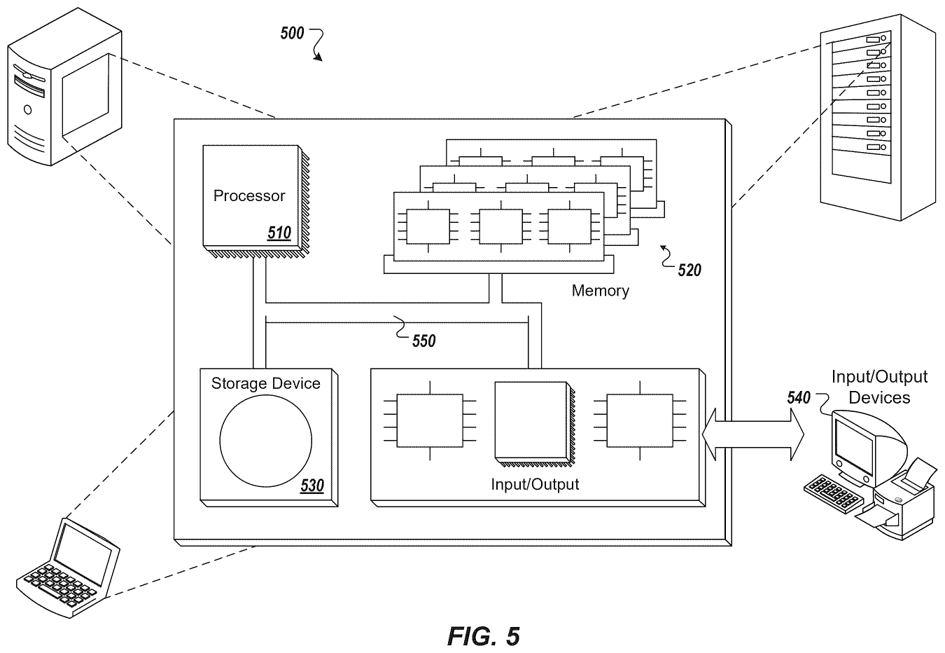

Referring now to FIG. 5, a schematic diagram of an example computing system 500 is provided. The system 500 can be used for the operations described in association with the implementations described herein. For example, the system 500 can be included in any or all of the server components discussed herein, such as the components of the example system 100 described with reference to FIG. 1. The system 500 includes a processor 510, a memory 520, a storage device 530, and an input/output device 540. The components 510, 520, 530, 540 are interconnected using a system bus 550. The processor 510 is capable of processing instructions for execution of processes (e.g., example process 300 described with reference to FIG. 3) within the system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 can be a floppy disk device, a hard disk device, an optical disk device, or a tape device. The input/output device 540 provides input/output operations for the system 500. In some implementations, the input/output device 540 includes a keyboard and/or pointing device. In some implementations, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a particular activity or bring about a particular result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a reservice-only memory or a random-access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps can be provided, or steps can be eliminated, from the described flows, and other components can be added to, or removed from, the described systems. A number of implementations of the present disclosure have been described. Nevertheless, it can be understood that various modifications can be made without departing from the spirit and scope of the present disclosure. In view of the above-described implementations of subject matter the application discloses the following list of examples, wherein one feature of an example in isolation or more than one feature of said example taken in combination and, optionally, in combination with one or more features of one or more further examples are further examples also falling within the disclosure of the application.

Example 1. A computer-implemented method comprising: receiving, by one or more processors, data comprising: (1) aggregated summary reports comprising hierarchically structured event-attributed affirmative action data as nodes distributed in a plurality of levels, the aggregated summary reports being generated by a first system, (2) event level reports comprising filtered interaction event data corresponding to interaction-events generated according to multiple affirmative action types that can be reported in a truncated format, the event level reports being generated by the first system, and (3) an additional raw affirmative action data representing raw affirmative action counts, at least a portion of the raw affirmative action counts being related to the hierarchically structured event-attributed affirmative action data and the filtered interaction event data, the additional raw affirmative action data being recorded by a second system; generating, by the one or more processors, a modeling space as a matrix comprising rows corresponding to interaction events and columns comprising the raw affirmative action data; determining, by the one or more processors, denoised aggregated counts from the aggregated summary reports and denoised event counts from the event level reports; generating, by the one or more processors, for each field of the matrix, input counts by encoding denoised aggregated counts and denoised event counts using the raw affirmative action data indicative of the interaction data; and optimizing, by the one or more processors, each field of the matrix, to generate an optimized matrix, by applying an optimization objective of selecting either a denoised event or a denoised aggregate, the optimization objective resolving conflicts between informational discrepancy between the raw affirmative action counts, the denoised aggregated counts, and the denoised event counts.

Example 2. The computer-implemented method of the preceding example, wherein optimizing, by the one or more processors, each field of the matrix comprises applying a constraint of having a set sum value for each portion of the matrix.

Example 3. The computer-implemented method of any of the preceding examples, wherein the auxiliary data comprises raw affirmative action counts corresponding to non-attributable affirmative action counts and attributable affirmative action counts.

Example 4. The computer-implemented method of any of the preceding examples, wherein the attributable affirmative action counts are defined according to an affirmative action type and an affirmative action value.

Example 5. The computer-implemented method of any of the preceding examples, wherein the optimized matrix comprises null values or unitary values in each field, wherein the unitary values indicate attribution of events and null values indicate lack of attribution of events.

Example 6. The computer-implemented method of any of the preceding examples, wherein the input counts are fractional or negative values.

Example 7. The computer-implemented method of any of the preceding examples, further comprising: determining, by the one or more processors, objective weights derived from the input counts; and applying, by the one or more processors, the objective weights to the input counts.

Example 8. A computer-implemented system comprising: memory storing application programming interface (API) information; and a server performing operations comprising: receiving, by one or more processors, data comprising: (1) aggregated summary reports comprising hierarchically structured event-attributed affirmative action data as nodes distributed in a plurality of levels, the aggregated summary reports being generated by a first system, (2) event level reports comprising filtered interaction event data corresponding to interaction-events generated according to multiple affirmative action types that can be reported in a truncated format, the event level reports being generated by the first system, and (3) an additional raw affirmative action data representing raw affirmative action counts, at least a portion of the raw affirmative action counts being related to the hierarchically structured event-attributed affirmative action data and the filtered interaction event data, the additional raw affirmative action data being recorded by a second system; generating, by the one or more processors, a modeling space as a matrix comprising rows corresponding to interaction events and columns comprising the raw affirmative action data; determining, by the one or more processors, denoised aggregated counts from the aggregated summary reports and denoised event counts from the event level reports; generating, by the one or more processors, for each field of the matrix, input counts by encoding denoised aggregated counts and denoised event counts using the raw affirmative action data indicative of the interaction data; and optimizing, by the one or more processors, each field of the matrix, to generate an optimized matrix, by applying an optimization objective of selecting either a denoised event or a denoised aggregate, the optimization objective resolving conflicts between informational discrepancy between the raw affirmative action counts, the denoised aggregated counts, and the denoised event counts.

Example 9. The computer-implemented system of the preceding example, wherein optimizing, by the one or more processors, each field of the matrix comprises applying a constraint of having a set sum value for each portion of the matrix.

Example 10. The computer-implemented system of any of the preceding examples, wherein the auxiliary data comprises raw affirmative action counts corresponding to non-attributable affirmative action counts and attributable affirmative action counts.

Example 11. The computer-implemented system of any of the preceding examples, wherein the attributable affirmative action counts are defined according to an affirmative action type and an affirmative action value.

Example 12. The computer-implemented system of any of the preceding examples, wherein the optimized matrix comprises null values or unitary values in each field, wherein the unitary values indicate attribution of events and null values indicate lack of attribution of events.

Example 13. The computer-implemented system of any of the preceding examples, wherein the input counts are fractional or negative values.

Example 14. The computer-implemented system of any of the preceding examples, wherein the operations further include determining, by the one or more processors, objective weights derived from the input counts; and applying, by the one or more processors, the objective weights to the input counts.

Example 15. A non-transitory computer-readable media encoded with a computer program, the computer program comprising instructions that when executed by one or more computers cause the one or more computers to perform operations comprising: receiving, by one or more processors, data comprising: (1) aggregated summary reports comprising hierarchically structured event-attributed affirmative action data as nodes distributed in a plurality of levels, the aggregated summary reports being generated by a first system, (2) event level reports comprising filtered interaction event data corresponding to interaction-events generated according to multiple affirmative action types that can be reported in a truncated format, the event level reports being generated by the first system, and (3) an additional raw affirmative action data representing raw affirmative action counts, at least a portion of the raw affirmative action counts being related to the hierarchically structured event-attributed affirmative action data and the filtered interaction event data, the additional raw affirmative action data being recorded by a second system; generating, by the one or more processors, a modeling space as a matrix comprising rows corresponding to interaction events and columns comprising the raw affirmative action data; determining, by the one or more processors, denoised aggregated counts from the aggregated summary reports and denoised event counts from the event level reports; generating, by the one or more processors, for each field of the matrix, input counts by encoding denoised aggregated counts and denoised event counts using the raw affirmative action data indicative of the interaction data; and optimizing, by the one or more processors, each field of the matrix, to generate an optimized matrix, by applying an optimization objective of selecting either a denoised event or a denoised aggregate, the optimization objective resolving conflicts between informational discrepancy between the raw affirmative action counts, the denoised aggregated counts, and the denoised event counts.

Example 16. The non-transitory computer-readable media of the preceding example, wherein optimizing, by the one or more processors, each field of the matrix comprises applying a constraint of having a set sum value for each portion of the matrix.

Example 17. The non-transitory computer-readable media of any of the preceding examples, wherein the auxiliary data comprises raw affirmative action counts corresponding to non-attributable affirmative action counts and attributable affirmative action counts and wherein the attributable affirmative action counts are defined according to an affirmative action type and an affirmative action value.

Example 18. The non-transitory computer-readable media of any of the preceding examples, wherein the optimized matrix comprises null values or unitary values in each field, wherein the unitary values indicate attribution of events and null values indicate lack of attribution of events.

Example 19. The non-transitory computer-readable media of any of the preceding examples, wherein the input counts are fractional or negative values.

Example 20. The non-transitory computer-readable media of any of the preceding examples, wherein the operations further include determining, by the one or more processors, objective weights derived from the input counts; and applying, by the one or more processors, the objective weights to the input counts.

1. A computer-implemented method comprising:
receiving, by one or more processors, data comprising:
(1) aggregated summary reports comprising hierarchically structured event-attributed affirmative action data as nodes distributed in a plurality of levels, the aggregated summary reports being generated by a first system,
(2) event level reports comprising filtered interaction event data corresponding to interaction-events generated according to multiple affirmative action types that can be reported in a truncated format, the event level reports being generated by the first system, and
(3) an additional raw affirmative action data representing raw affirmative action counts, at least a portion of the raw affirmative action counts being related to the hierarchically structured event-attributed affirmative action data and the filtered interaction event data, the additional raw affirmative action data being recorded by a second system;
generating, by the one or more processors, a modeling space as a matrix comprising rows corresponding to interaction events and columns comprising the raw affirmative action data;
determining, by the one or more processors, denoised aggregated counts from the aggregated summary reports and denoised event counts from the event level reports;
generating, by the one or more processors, for each field of the matrix, input counts by encoding denoised aggregated counts and denoised event counts using the raw affirmative action data indicative of the interaction data; and
optimizing, by the one or more processors, each field of the matrix, to generate an optimized matrix, by applying an optimization objective of selecting either a denoised event or a denoised aggregate, the optimization objective resolving conflicts between informational discrepancy between the raw affirmative action counts, the denoised aggregated counts, and the denoised event counts.

2. The computer-implemented method of claim 1, wherein optimizing, by the one or more processors, each field of the matrix comprises applying a constraint of having a set sum value for each portion of the matrix.

3. The computer-implemented method of claim 1, wherein the auxiliary data comprises raw affirmative action counts corresponding to non-attributable affirmative action counts and attributable affirmative action counts.

4. The computer-implemented method of claim 3, wherein the attributable affirmative action counts are defined according to an affirmative action type and an affirmative action value.

5. The computer-implemented method of claim 1, wherein the optimized matrix comprises null values or unitary values in each field, wherein the unitary values indicate attribution of events and null values indicate lack of attribution of events.

6. The computer-implemented method of claim 1, wherein the input counts are fractional or negative values.

7. The computer-implemented method of claim 1, further comprising:
determining, by the one or more processors, objective weights derived from the input counts; and
applying, by the one or more processors, the objective weights to the input counts.

8. A computer-implemented system comprising:
memory storing application programming interface (API) information; and
a server performing operations comprising:
receiving, by one or more processors, data comprising:
(1) aggregated summary reports comprising hierarchically structured event-attributed affirmative action data as nodes distributed in a plurality of levels, the aggregated summary reports being generated by a first system,
(2) event level reports comprising filtered interaction event data corresponding to interaction-events generated according to multiple affirmative action types that can be reported in a truncated format, the event level reports being generated by the first system, and
(3) an additional raw affirmative action data representing raw affirmative action counts, at least a portion of the raw affirmative action counts being related to the hierarchically structured event-attributed affirmative action data and the filtered interaction event data, the additional raw affirmative action data being recorded by a second system;
generating, by the one or more processors, a modeling space as a matrix comprising rows corresponding to interaction events and columns comprising the raw affirmative action data;
determining, by the one or more processors, denoised aggregated counts from the aggregated summary reports and denoised event counts from the event level reports;
generating, by the one or more processors, for each field of the matrix, input counts by encoding denoised aggregated counts and denoised event counts using the raw affirmative action data indicative of the interaction data; and
optimizing, by the one or more processors, each field of the matrix, to generate an optimized matrix, by applying an optimization objective of selecting either a denoised event or a denoised aggregate, the optimization objective resolving conflicts between informational discrepancy between the raw affirmative action counts, the denoised aggregated counts, and the denoised event counts.

9. The computer-implemented system of claim 8, wherein optimizing, by the one or more processors, each field of the matrix comprises applying a constraint of having a set sum value for each portion of the matrix.

10. The computer-implemented system of claim 8, wherein the auxiliary data comprises raw affirmative action counts corresponding to non-attributable affirmative action counts and attributable affirmative action counts.

11. The computer-implemented system of claim 10, wherein the attributable affirmative action counts are defined according to an affirmative action type and an affirmative action value.

12. The computer-implemented system of claim 8, wherein the optimized matrix comprises null values or unitary values in each field, wherein the unitary values indicate attribution of events and null values indicate lack of attribution of events.

13. The computer-implemented system of claim 8, wherein the input counts are fractional or negative values.

14. The computer-implemented system of claim 8, wherein the operations further comprise:
determining, by the one or more processors, objective weights derived from the input counts; and
applying, by the one or more processors, the objective weights to the input counts.

15. A non-transitory computer-readable media encoded with a computer program, the computer program comprising instructions that when executed by one or more computers cause the one or more computers to perform operations comprising:
receiving, by one or more processors, data comprising:
(1) aggregated summary reports comprising hierarchically structured event-attributed affirmative action data as nodes distributed in a plurality of levels, the aggregated summary reports being generated by a first system,
(2) event level reports comprising filtered interaction event data corresponding to interaction-events generated according to multiple affirmative action types that can be reported in a truncated format, the event level reports being generated by the first system, and
(3) an additional raw affirmative action data representing raw affirmative action counts, at least a portion of the raw affirmative action counts being related to the hierarchically structured event-attributed affirmative action data and the filtered interaction event data, the additional raw affirmative action data being recorded by a second system;
generating, by the one or more processors, a modeling space as a matrix comprising rows corresponding to interaction events and columns comprising the raw affirmative action data;
determining, by the one or more processors, denoised aggregated counts from the aggregated summary reports and denoised event counts from the event level reports;
generating, by the one or more processors, for each field of the matrix, input counts by encoding denoised aggregated counts and denoised event counts using the raw affirmative action data indicative of the interaction data; and
optimizing, by the one or more processors, each field of the matrix, to generate an optimized matrix, by applying an optimization objective of selecting either a denoised event or a denoised aggregate, the optimization objective resolving conflicts between informational discrepancy between the raw affirmative action counts, the denoised aggregated counts, and the denoised event counts.

16. The non-transitory computer-readable media of claim 15, wherein optimizing, by the one or more processors, each field of the matrix comprises applying a constraint of having a set sum value for each portion of the matrix.

17. The non-transitory computer-readable media of claim 15, wherein the auxiliary data comprises raw affirmative action counts corresponding to non-attributable affirmative action counts and attributable affirmative action counts and wherein the attributable affirmative action counts are defined according to an affirmative action type and an affirmative action value.

18. The non-transitory computer-readable media of claim 15, wherein the optimized matrix comprises null values or unitary values in each field, wherein the unitary values indicate attribution of events and null values indicate lack of attribution of events.

19. The non-transitory computer-readable media of claim 15, wherein the input counts are fractional or negative values.

20. The non-transitory computer-readable media of claim 15, wherein the operations further comprise:
determining, by the one or more processors, objective weights derived from the input counts; and
applying, by the one or more processors, the objective weights to the input counts.
